(19) United States
(12) Patent Application Publication
(10) Pub. No.: US 2014/0199488 A1
(43) Pub. Date: Jul. 17, 2014

(54) Cement Hydrate Products For Sprayed Concrete

(71) Applicants: Montserrat Alfonso, Wettswil am Albis (CH); Elena Kolomiets, Moehlin (CH)

(72) Inventors: Montserrat Alfonso, Wettswil am Albis (CH); Elena Kolomiets, Moehlin (CH)

(73) Assignee: CONSTRUCTION RESEARCH & TECHNOLOGY GMBH, Trostberg (DE)

(21) Appl. No.: 13/988,553

(22) PCT Filed: Nov. 22, 2011
(86) PCT No.: PCT/EP2011/070677

§ 371 Date: Sep. 17, 2013

(30) Foreign Application Priority Data
Nov. 30, 2010 (EP) 10193123.6

(51) Int. Cl. C04B 22/14; B05D 1/02

(52) U.S. Cl. CPC C04B 22/148; B05D 1/02
USPC 427/427; 106/736; 106/735

(57) ABSTRACT

Process for the preparation of a sprayable inorganic binder composition containing as main components water, aggregates, inorganic binder, set accelerator, characterized in, that a cement hydrate products containing component is added before and/or at the spray nozzle.

The present invention relates to a process for a preparation of a sprayable inorganic binder composition, a sprayable inorganic binder composition and a method of the use of the composition.

### BACKGROUND OF THE INVENTION

The application of cementitious compositions such as concrete to a substrate by spraying from a nozzle is a well-established technology, and is widely used in such applications as ground support and the lining of tunnels. It is a requirement that such compositions are able to be easily conveyed (usually by pumping) to a spray nozzle. This can be achieved by the addition to the cementitious composition that is to be pumped and sprayed, at the mix stage, of an admixture which confers improved fluidity of the mix. There is a considerable variety of such admixtures known to and used by the art, for example, sulfonated melamine formaldehyde condensate, sulfonated naphthalene formaldehyde condensate, or acrylic polymer families.

Sprayed concrete or “shotcrete” is mainly used in underground construction. Its application consists in the conveying of a mortar or concrete to a nozzle, where a set accelerating admixture and air are added, and it's pneumatically projection at high velocity onto a substrate. Indeed, fast setting and early strength development are needed to allow concrete adhesion on the wall without falls and hence earlier entrance and further excavation are ensured, guarantying security and efficient construction. For this reason, accelerators which ensure rapid development of the mechanical properties are added to the sprayed concrete or sprayed mortar.

It is known that set accelerators influence the hydration process of clinker phases such as C3A and C3S, the consumption of the sulfate carriers and the chemical composition of the concrete pore solution at the very beginning stage.

A process for the preparation of a liquid accelerator is described in EP 08170692.1, wherein the liquid accelerator containing aluminum sulfate and/or aluminum hydroxy sulfate. EP1878713 describes an accelerating admixture that is based on 25 to 40% by weight of aluminum sulfate, at least one further aluminum compound, so that the molar ratio of aluminum to sulfate in the dispersion is 1.35 to 0.70 and an inorganic stabilizer, which comprises a magnesium silicate. A process of applying a layer of cementitious composition on a substrate by spraying the cementitious composition is described in EP 0812812. An accelerating admixture and hardening accelerator for inorganic binder according to EP 1964825 comprises sulfate, aluminum, organic acid and/or mineral acid and silicic acid. WO 2005/075381 describes a water-based accelerating admixture and a hardening accelerator for inorganic binder, comprising sulfate, aluminum and organic acid, wherein the molar ratio of aluminum to organic acid is less than 0.65.

Conventional setting accelerators for sprayed concrete (shotcrete) and other cement-containing materials are distinguished in that they either result in rapid setting and relatively low early strength or lead to slow setting in combination with relatively high early strength.

Furthermore, admixtures for building material mixtures comprising inorganic binders typically also contain hardening accelerators which increase the early strength development rate of the inorganic binder.

According to WO 02/070425, calcium silicate hydrates, can be used as such a hardening accelerator. However, commercially available calcium silicate hydrates and dispersions thereof may be regarded only as hardening accelerators which have little effect.

The object of the invention is to provide a sprayable inorganic binder composition as e.g. sprayed concrete or sprayed mortar for the coating of substrates, in particular tunnel surfaces, mine surfaces, construction trenches and shafts, with concrete or mortar.

Surprisingly it has been found a new chemical system to accelerate setting and early strength development in inorganic binder compositions, in particular in sprayed concrete or sprayed mortar.

### DETAILED DESCRIPTION OF THE INVENTION

The disadvantage of known set accelerating admixtures is that the provided fast setting results very often in a slow early strength development in inorganic binder containing compositions such as sprayed concrete.

It is an object of the present invention to provide a process for the preparation of a sprayable inorganic binder composition containing as main components water, aggregates, inorganic binder and a set accelerator, characterized in, that a cement hydrate product containing component is added before and/or at the spray nozzle.

Surprisingly it has been found that cement hydrate products improve the performance of set accelerators in inorganic binder compositions and thereby creates a higher hardening of the inorganic binder.

The invention therefore provides a new chemical system to accelerate setting and early strength development in inorganic binder compositions, in particular in sprayed concrete. It has now been found that a specific chemical system may be prepared by the combination of (1) a hardening admixture and (2) a set accelerator. The (1) hardening admixture contains cement hydrate products. The cement hydrate products contain ettringite and gypsum. The (2) set accelerator consists of any type of alkali-free or alkali-containing set accelerator for sprayed concrete on the basis of e.g. aluminium sulfate or sodium silicate. The hardening accelerator can be as well added simultaneously with the set accelerator at the nozzle.

Especially when sprayed on a substrate, a cementitious composition, such as concrete, must set very quickly. For such a use, powerful accelerators including sodium aluminate and alkali metal hydroxide have been used. However, since these accelerators are highly alkaline, its use resulted in very unpleasant handling and working conditions. Therefore, low alkali and alkali-free accelerators have been proposed containing aluminum compounds.

Usual alkali-free setting accelerators for sprayed concrete and other cement-containing materials are distinguished in that either they result in rapid setting and relatively low early strength or lead to slow setting in combination with relatively high early strength.

In a preferred embodiment of the present invention the inorganic binder is clinker, gypsum, calcium sulfate, bassanite (calcium sulphate hemihydrate), anhydrite (anhydrous calcium sulphate), lime, a latent inorganic binder (e.g. fly ash, blast furnace slag or pozzolans), and mixtures thereof, preferably Portland cement.

Cement is typically used in the construction industry as finely ground inorganic binder for making concrete, mortar, concrete stones and finished parts.

Portland cement is a basic ingredient of concrete, mortar and most non-speciality grout. The most common use for Portland cement is in the production of concrete. Concrete is a composite material mainly consisting of aggregate (gravel and sand), cement, and water. As a construction material, concrete can be cast in almost any shape desired, and once hardened, can become a structural (load bearing) element. Portland cement may be a gray or white one.

In a preferred embodiment, the aggregates are selected from the group consisting of sand, organic and/or inorganic granulates, gravel, preferably with a size distribution from 0-16 mm, more preferably 0-8 mm.

In a preferred embodiment the set accelerator contains as main components sulfate, aluminium in oxidation state +3 or mixtures thereof.

U.S. Pat. No. 5,340,385 discloses that several chemical set accelerators are well-known. Included and comprised by the present invention are alkali hydroxides, silicates, fluorosilicates, calcium formate, sodium chloride, calcium chloride, calcium nitrate and calcium nitrite.

Additionally, the set accelerating effect on cement is increased by mixing the amorphous aluminum hydroxide with water-soluble sulfates, nitrates and formates of the alkaline earth and transition metals.

In a preferred embodiment the set accelerator contains sulfate in amounts between 15 and 40%, by weight, referred to the weight of said accelerator, and/or aluminum in oxidation state 3 in amounts between 3 and 10% by weight, referred to the weight of said accelerator.

In a preferred embodiment of the invention the cement hydrate products are ettringite and gypsum.

In a further preferred embodiment the cement hydrate products is a suspension or a solid, preferably a suspension.

In a preferred embodiment, the inorganic binder is used in amounts from 300 to 600 kg/m³, preferably 350 to 500 kg/m³, more preferably 380 to 450 kg/m³.

In a further preferred embodiment the cement hydrate products is added to the inorganic binder in the cement plant, in the ready-mix plant, to the truck mixer, to the convey pump and/or at the spray nozzle, more preferably to the batching water.

A further preferred embodiment of this invention is a sprayable inorganic binder containing composition which can be prepared by a process.

The invention furthermore comprises a sprayable inorganic binder containing composition additionally comprising a superplasticizer, preferably a polycarboxylate ether and more preferably a dispersion thereof.

Plasticizers or dispersants are additives that increase the plasticity or fluidity of the material to which they are added, these include cement, concrete, wallboard and clay bodies. Plasticizers for concrete fluidify the mix before it hardens, increasing its workability or reducing water, and are usually not intended to affect the properties of the final product after it hardens. Additionally, concrete superplasticizers are polycarboxylate ether polymer-based composite admixtures and/or sulfonated melamine formaldehyde condensate, sulfonated naphthalene formaldehyde condensate, or acrylic polymer families. It has the advantageous effect of a slump retention ability. It is specially adapted to the production of high durability concrete, selfcompacting concrete, high workability-retaining concrete, and also concrete with good appearance requirement.

Finally, the invention comprises a method of use of the composition for the coating of substrates with sprayed concrete or sprayed mortar.

By spraying the inorganic binder composition over head its load bearing capability is increased. The sprayable inorganic binder composition may also be applied to reduce or prevent weathering, that is the erosion of freshly exposed rock surfaces by air in the tunnel or mine, for the suppression of radon gas in an uranium mine or for stabilizing embankments for example in a quarry, for stabilizing roofs of tunnels or the like.

According to this invention the terms “concrete” and “mortar”, respectively “sprayed concrete” and “sprayed mortar”, may also comprise other cementitous materials. For example cement based grouts for mining and cementitous mortars for fire protection of concrete.

The invention is to be described in more detail below with reference to working examples.

### EXAMPLES

### Preparation of Ettringite Suspensions

### Example 1

Addition of saturated solution of calcium hydroxide to aluminum sulfate solution (AFt 1):

All solutions were made with deionized water. A saturated solution of calcium hydroxide was prepared by adding excess CaO to distilled water, stirring the covered solution for 2 h with a magnetic stir bar and then filtering the liquid. Aluminum sulfate solution was produced by adding 63 g of Al₂(SO₄)₃.16H₂O to 500 ml of distilled water followed by filtering. After addition of saturated solution of calcium hydroxide to aluminum sulfate solution mixture was left for 24 h, then formed visible precipitate was filtered and rinsed with a small quantity of distilled water.

### Example 2

Addition of sodium aluminate NaAl(OH)₄ to calcium sulfate (AFt 2):

51.6 g of gypsum was added to 350 ml of water and stir for 1 h. Then 20.8 g of aluminum hydroxide (75%) and 42.7 g of NaOH 30% bw aqueous solution was added to the slurry and stirred for 24 h at room temperature.

### Example 3

Addition of calcium nitrate solution to aluminum sulfate in the presence of sodium (AFt 3):

An aluminum sulfate solution was prepared by adding 63 g of Al₂(SO₄)₃.16H₂0 to 500 ml of distilled water followed by filtering. Prepared aluminum sulfate solution was added drop wise to the 112 g of NaOH 30% bw aqueous solution and 300 ml water (pH 13). 4M calcium nitrate solution was added then drop wise in the reaction mixture and stirred for 24 h.

### Example 4

Reaction of tricalcium aluminate C3A and a sulfaze source with water (AFt 4):

C3A in presence of gypsum, bassanite, anhydrite and/or soluble sulfate-salts is mixed with water.

Application Experiments

### Example 5

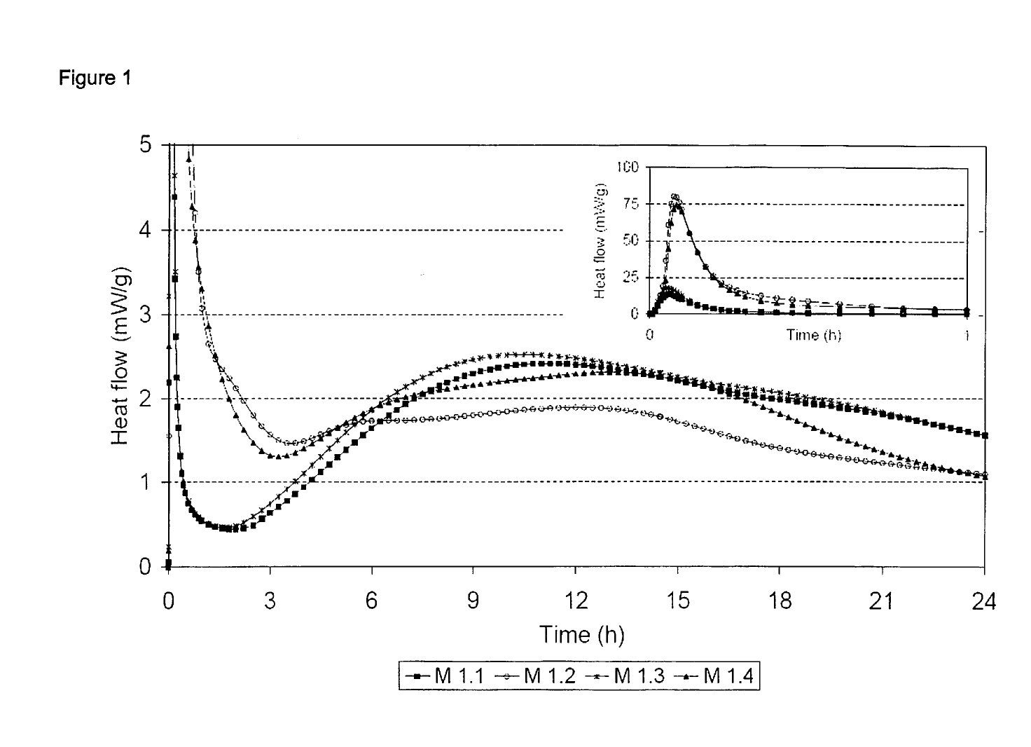

Influence on the early hydration kinetics of ettringite addition (FIG. 1)

This example shows the effect of the inventive combination of ettringite (AFt 1) and a set accelerator on the early hydration kinetics of Portland cement paste.

To measure the hydration kinetics, 2 g of cement were weighted in a glass ampoule which is tightly sealed immediately after mixing with the water or admixture-water solution (the admixtures, if required, were previously dissolved in the water) and then placed into an isothermal calorimeter TAM Air. The isothermal measurements were performed at the temperature of 20° C.

Said cement paste mixtures are composed as follows:

TABLE 1

| Component (in g) | M 1.1 | M 1.2 | M 1.3 | M 1.4 |
|---|---|---|---|---|
| CEM II/A-LL 42.5N HOLCIM | 2.000 | 2.000 | 2.000 | 2.000 |
| Fluvio ® 4 | | | | |
| Water | 1.0 | 1.0 | 1.0 | 1.0 |
| Ettringite suspension (AFt 1) | — | — | 0.02 | 0.02 |
| Set accelerator | — | 0.16 | — | 0.16 |

The set accelerator 1 is alkali-free and based on aluminum hydroxysulfate.

The results are shown in FIG. 1. The lines are isothermal calorimetric data, and the symbols identify individual data sets. The addition of ettringite suspension (AFt 1) has a significant accelerating effect on both hydration peaks. On the other hand the addition of set accelerator has a significant accelerating effect on the first (dissolution) peak but retardation on the second (CSH) peak. The combination of both shows acceleration of both hydration peaks.

### Example 6

Influence of the inventive combination on the setting time of a Portland cement Type II.

In the example 6 the effect of an alkali-free set accelerator on the setting time of a Portland cement Type II is compared with the effect of the inventive combination. Mortars prepared according to the European Norm EN 196-1 were chosen as mixtures for examination. Said mixtures are composed as follows:

TABLE 2.1

| Component (in g) | M 2.1 | M 2.2 | M 2.3 |
|---|---|---|---|
| CEM II/A-L 42.5 N CIMPOR | 450 | 450 | 450 |
| Norm sand EN 196 | 1350 | 1350 | 1350 |
| Water | 202.5 | 202.5 | 202.5 |
| High range superplasticizer | 1.36 | 1.42 | 1.32 |
| Ettringite suspension (AFt 1) | | 2.25 | |
| Gypsum suspension | | | 2.25 |
| Alkali-free set accelerator | 40.5 | 40.5 | 40.5 |

The mortar samples were examined with an automatic Vicat needle apparatus, which measures the initial and final set of mortar mixes with admixtures as per EN 480-2.

The positive influence of the combination of Ettringite (AFt 1) and gypsum (Gy) in combination with a set accelerator on the setting is obvious and can be seen in Table 2.2. The addition of both ettringite (AFt 1) and gypsum (Gy) in combination with a set accelerator reduces the initial and final set compared with the conventional set accelerator alone with this Portland cement Type II.

TABLE 2.2

| Parameter | M 2.1 | M 2.2 | M 2.3 |
|---|---|---|---|
| Initial set manual min (EN 480-2) | 2.5 | <2 | 2.0 |
| Final set manual min (EN 480-2) | 12.5 | 7.0 | 6.0 |

### Example 7

Influence of the inventive combination on the early strength development of a Portland cement Type II

In the example 7 the effect of an alkali-free set accelerator on the early strength development of a Portland cement Type II is compared with the effect of the inventive combination (AFt 2+set accelerator). Mortars prepared according to the European Norm EN 196-1 were chosen as mixtures for examination. Said mixtures are composed as follows:

TABLE 3

| Component (in g) | M 3.1 | M 3.2 |
|---|---|---|
| CEM II/A-LL 42.5N HOLCIM Fluvio ® 4 | 450 | 450 |
| Norm sand EN 196 | 1350 | 1350 |
| Water | 202.5 | 202.5 |
| High range suerplasticizer | 0.9 | 1.35 |
| Ettringite suspension (AFt 2) | | 2.25 |
| Alkali-free set accelerator | 36 | 36 |

The mortar samples were examined with a penetrometer prototype of the company LBG, which measures and records a continuous gradual increase of the consistency of the mixtures.

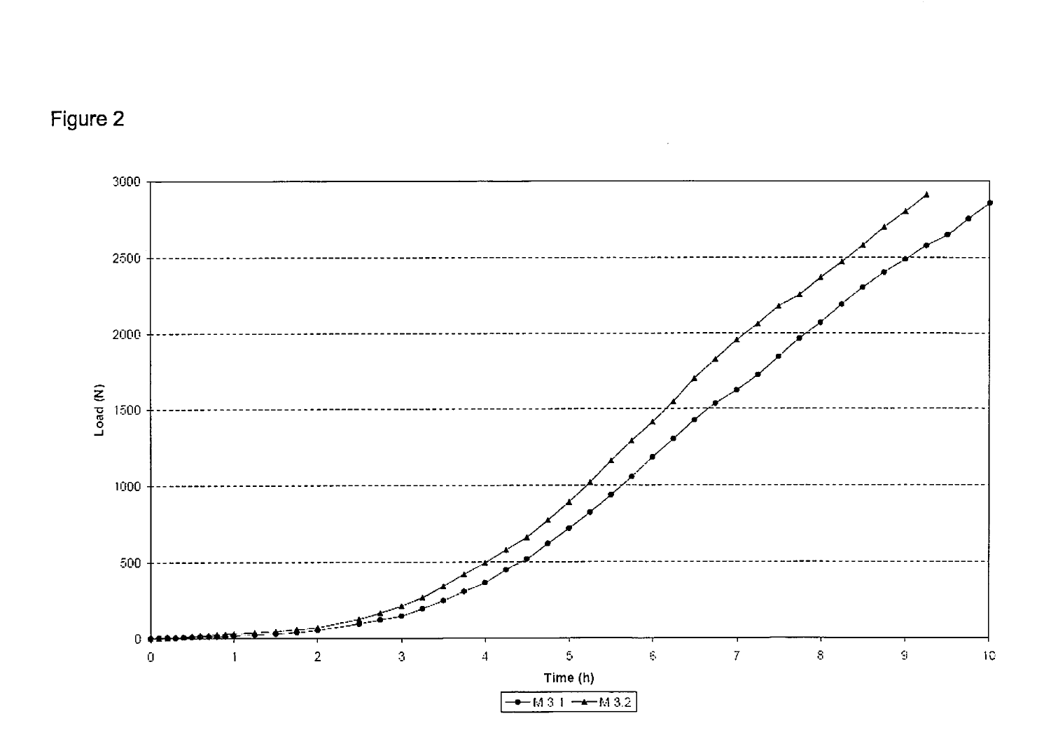

The positive influence of the combination of ettringite (AFt 2) and set accelerator on the early strength development is obvious and can be seen in FIG. 2. The combination of ettringite (AFt 2) with a set accelerator results in a faster early strength development compared to the conventional set accelerator alone with this Portland cement Type II.

1. A process for the preparation of a sprayable inorganic binder composition containing as main components water, aggregates, inorganic binder, and set accelerator, wherein a cement hydrate products containing component is added before and/or at the spray nozzle.

2. The process according to claim 1, wherein the inorganic binder is cement, gypsum, bassanite, anhydrite, lime, latent inorganic binder, fly ash, blast furnace slag, pozzolans, or mixtures thereof.

3. The process according to claim 1, wherein the aggregates are selected from the group consisting of sand, granulates, and gravel, optionally with a size distribution from 0-16 mm.

4. The process according to claim 1, wherein the set accelerator additionally contains as main components sulfate, aluminium in oxidation state +3 or mixtures thereof.

5. The process according to claim 1, wherein the set accelerator contains sulfate in amounts between 15 and 40%, by weight, based on the weight of said accelerator, and/or aluminum in oxidation state 3 in amounts between 3 and 10% by weight, based on the weight of said accelerator.

6. The process according to claim 1, wherein the cement hydrate products are ettringite and/or gypsum.

7. The process according to claim 1, wherein the cement hydrate products are in a liquid or in solid form, preferably optionally a dispersion.

8. The process according to claim 1, wherein the inorganic binder is used in amounts from 300 to 600 kg/m³.

9. The process according to claim 1, wherein the cement hydrate products containing component is added to the inorganic binder in the cement plant, in the ready-mix plant, to the truck mixer, to the convey pump and/or to the spray nozzle.

10. A sprayable inorganic binder containing composition prepared by a process according to claim 1.

11. A composition according to claim 10, containing additionally a superplasticizer, optionally a polycarboxylate ether and further optionally as a suspension.

12. A method of the use of the composition of claim 11, comprising spraying a coating of substrates as sprayed concrete or sprayed mortar.

13. A method of the use of the composition of claim 10, comprising spraying a coating of substrates as sprayed concrete or sprayed mortar.

14. The process according to claim 3, wherein the aggregates have a size distribution from 0-8 mm.

15. The process according to claim 1, wherein the inorganic binder is used in amounts from 380 to 500 kg/m³.

16. The process according to claim 1, wherein the inorganic binder is used in amounts from 350 to 450 kg/m³.

17. The process according to claim 1, wherein the inorganic binder is Portland cement.
